(19) United States
(12) Patent Application Publication
(10) Pub. No.: US 2011/0272495 A1
(43) Pub. Date: Nov. 10, 2011

(54) FUEL INJECTOR AND INTERNAL COMBUSTION ENGINE HAVING A FUEL INJECTOR

(75) Inventors: Predrag Nunic, Stuttgart (DE); Andreas Koeninger, Neulingen-Goebrichen (DE)

(73) Assignee: Robert Bosch GmbH, Stuttgart (DE)

(21) Appl. No.: 13/145,137

(22) PCT Filed: Nov. 19, 2009
(86) PCT No.: PCT/EP2009/065434

§ 371 Date: Jul. 19, 2011

(30) Foreign Application Priority Data
Jan. 19, 2009 (DE) 102009000285.5

(51) Int. Cl. F02M 63/00

(52) U.S. Cl. 239/533.2

(57) ABSTRACT

The invention relates to a fuel injector (1), in particular a common rail injector, for injecting fuel into a combustion chamber (9) of an internal combustion engine (5), having a nozzle body (8) designed for protruding into the combustion chamber (9) and tightened to a retaining element by means of a nozzle clamping nut (3), and having a seal (6) for sealing off the combustion chamber (9) from a nozzle body area.

### BACKGROUND OF THE INVENTION

The invention relates to a fuel injector, in particular a common rail injector, for injecting fuel into a combustion chamber of an internal combustion. Furthermore, the invention relates to an internal combustion engine having at least one fuel injector.

DE 10 2005 053 112 A1 describes a fuel injector which is assigned a sealing element with which the combustion chamber of an internal combustion engine is sealed off from the surroundings. The sealing element is secured by a securing element.

The outer geometry of known fuel injectors and in particular the outer geometry of the nozzle body projecting into the combustion chamber of an internal combustion engine is substantially identical in virtually all types and shapes of fuel injectors and is distinguished by a long shank which is installed in a corresponding receiving bore in the cylinder head of the internal combustion engine. The nozzle shank has direct contact with the internal combustion engine, i.e. it is acted upon by the combustion gases and the chemical and reactive intermediate and reaction products thereof, for example atomic hydrogen, in the annular space to the cylinder head. The nozzle body of known fuel injectors is clamped to a holding body (housing part) of the fuel injector by force being applied to a nozzle body shoulder by means of a nozzle clamping nut, in order to produce internal sealing forces against hydraulic leakages. The entire fuel injector is clamped into the cylinder head with an axial clawing force in order to seal off the combustion chamber from the surroundings. For this purpose, it is known to insert copper sealing disks having inner lugs for centering purposes. Rising injection and combustion pressures in future development generations, in particular in common rail injectors, which are under a permanent hydraulic internal pressure, require a rise in the sealing forces, which leads to high mechanical stresses in an upper region of the nozzle shank, in particular at the transition to the nozzle collar of the nozzle body.

### SUMMARY OF THE INVENTION

The invention is based on the object of proposing a fuel injector, the nozzle body of which is better protected against chemical and reactive intermediate and reaction products of the combustion in the combustion chamber of the internal combustion engine. Furthermore, it is the object to specify an internal combustion engine having a fuel injector of this type. In particular, the nozzle body of the fuel injector should be protected against combustion products irrespective of a concentricity offset between the clamping nut and nozzle body.

The invention is based on the concept of protecting points of the nozzle body which are critical in terms of strength, in particular a transition region between a nozzle shank and a nozzle collar, against condensate and/or chemical and reactive intermediate and reaction products of the combustion by the provision of at least one seal. By the provision of a seal of this type which is designed and arranged to protect at least one nozzle body region which is critical in terms of strength, in particular as per the variant embodiments explained below, corrosion pits and hydrogen-induced “stress corrosion cracking” on the nozzle body, in particular on the nozzle shank, can be avoided. Without a seal of this type, these effects could ultimately lead to the nozzle body failing due to fracturing.

An embodiment of the fuel injector and of the internal combustion engine is very particularly preferred, in which the single-part or multipart seal is arranged at least partially axially between the nozzle body, preferably between the collar of the nozzle body and the clamping nut. In addition or as an alternative, the seal may be arranged at least partially axially between the clamping nut and the internal combustion engine.

In order to obtain an optimum sealing effect, it is preferred if the seal comprises an elastomer compound (elastic, preferably rubber-elastic sealing compound). By means of the elastic deformation during assembly of the fuel injector and/or during installation of the fuel injector into the internal combustion engine, an optimum, tolerance-insensitive sealing effect can be obtained by the elastic deformation of the sealing compound. A further advantage of providing an elastomeric sealing compound is that a captive function is achieved at the same time during the assembly by means of the high elastic radial forces with which the sealing compound is preferably supported on the nozzle shank of the nozzle body.

An embodiment is very particularly preferred, in which the elastic sealing compound is vulcanized onto a metal disk, in particular a copper disk, i.e. is connected fixedly and immovably to the metal disk. In this case, it is furthermore preferred if the elastic sealing compound bears radially on the nozzle shank of the nozzle body. It is furthermore preferred if the sealing compound additionally bears on the cylinder head or the nozzle body in the axial direction. The metal disk which is provided with the elastic sealing compound then not only has the task of sealing off the combustion chamber from the surroundings but also of producing gastightness between a shank step (transition region between the nozzle shank and nozzle collar) and the combustion chamber. As already indicated, it is preferred to arrange the elastomeric sealing compound on the inside diameter of the metal disk. For this purpose, the inner geometry of the metal disk is preferably correspondingly shaped, for example provided with a toothed profile, in order to achieve an improved connection between sealing compound and metal disk. During the assembly, the metal disk which is provided with the elastic sealing compound is preferably pulled in a self-centering manner onto a conical nozzle shank section and, by this means, is fully tolerance-insensitive in relation to the concentric offset between clamping nut and nozzle body.

As mentioned at the beginning, the sealing compound can be arranged in a radially and/or axially sealing manner. In the case of an axially sealing arrangement in which the sealing compound preferably bears directly on the internal combustion engine, in particular on the cylinder head, the sealing compound preferably comprises for this purpose an (axial) sealing lip which ensures that the combustion chamber is sealed off in a gastight manner from the surroundings.

In an alternative embodiment, the sealing compound is not vulcanized onto a metal disk but rather is formed as an independent component which is held in a form-fitting manner on the single-part or multipart metal disk, in particular copper disk.

A multipart design of the metal disk is preferred in this case, the (entire) metal disk preferably being formed by a plurality of metal disks arranged axially next to one another. For most application purposes, it will be sufficient to form the metal disk from two axially adjacent metal disks, wherein the metal disks form, on the inner circumference therebetween, a groove in which the elastomeric annular element is held. For different sealing disk thicknesses which are to be applied, it is possible to provide at least one further disk which preferably serves at the same time as a supporting disk for the elastomer ring (annular element).

In a further alternative embodiment, in which the elastic sealing compound is designed as an independent annular element, the latter can be held in an axial undercut of the nozzle collar of the nozzle body. In other words, a groove for holding an elastic annular element is provided on the end side of the nozzle collar. In this alternative, as a result of a suitable geometry of the undercut, the maximum mechanical stresses which occur in an upper region which is shielded from condensate and condensate products by the annular element, which is designed in particular as an O-ring. The required surface pressures in the undercut groove can be set in a specific manner by the high degree of accuracy of the annular element diameter (preferably O-ring diameter) and the undercut dimensions. It is thus possible to jointly grind the nozzle body shoulder (nozzle collar) and the groove on the end side into shape in one operation. The concentric offset of the nozzle clamping nut with respect to the nozzle body can be compensated for by an additional metal disk which is designed as a supporting disk, as a result of which the introduction of force into the annular element is homogeneous. A further advantage of the previously described alternative is that the additional metal disk, which acts as a supporting disk, can act on the intersection between the nozzle shoulder and clamping nut in a manner reducing the moment of friction.

In a further alternative embodiment, the seal is designed as a collar sleeve which is preferably free of elastomer compound, an embodiment also being conceivable, however, in which the collar sleeve is provided with elastomer material or interacts with an elastomeric element. During the manufacturing, a metallic and preferably corrosion-resistant collar sleeve is preferably pulled over the nozzle shank region which is critical in terms of strength and corrosion. The collar sleeve is preferably a shrink-on sleeve which is shrunk onto the nozzle shank. The collar sleeve can be designed, for example, as a cost-effective deep drawn part made of high-grade steel. As a result of the high degree of accuracy of the nozzle shank diameter, a robust oversize configuration is possible. A further advantage of this alternative is that the collar sleeve can act on the intersection between the nozzle body shoulder and clamping nut in a manner reducing the moment of friction.

Furthermore, the invention leads to an internal combustion engine having a previously described fuel injector, wherein the fuel injector is assigned a seal which is designed as previously described and provides protection against combustion products from the internal combustion engine for those regions of the nozzle body of the fuel injector which are at risk. Said region at risk is preferably a transition region between a nozzle shank and a nozzle collar of the nozzle body.

### BRIEF DESCRIPTION OF THE DRAWINGS

Further advantages, features and details of the invention emerge from the description below of preferred exemplary embodiments and with reference to the drawings, in which:

FIG. 1a shows a top view of the fuel injector according to FIG. 1b in a viewing direction A,

FIG. 1b shows an internal combustion engine with a fuel injector, wherein the fuel injector is assigned a seal which is arranged axially between a nozzle clamping nut and a cylinder head of the internal combustion engine,

FIG. 2 shows an alternative embodiment of a fuel injector with a seal which is designed as a collar sleeve,

FIG. 3 shows a further alternative embodiment of a fuel injector, in which the seal consists of an annular, elastic sealing element and a metal disk, wherein the two components of the seal are arranged axially between a nozzle collar of a nozzle body and a nozzle clamping nut,

FIG. 4 shows a further alternative embodiment of a fuel injector with a two-part seal, comprising an O-ring sealing element and a metal disk with an inner circumferential groove for the form-fitting receiving or the form-fitting holding of the elastomer seal, and

FIG. 5 shows a further alternative embodiment of a fuel injector, in which, in contrast to the exemplary embodiment according to FIG. 4, the metal disk is of two-part design.

### DETAILED DESCRIPTION

Identical elements and elements having the same function are identified in the figures by the same reference numbers.

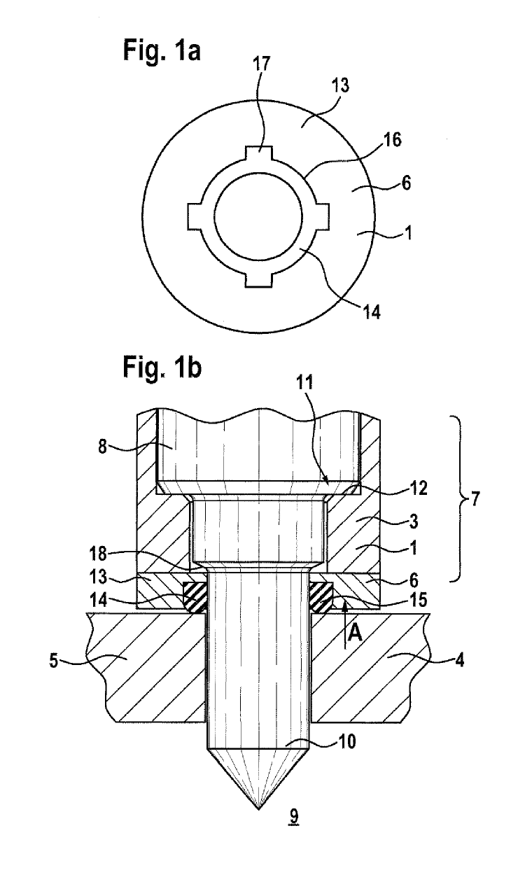

FIGS. 1a and 1b show a fuel injector 1. The latter comprises a seal 6 axially between a lower annular end side 2 of a nozzle clamping nut 3 and a cylinder head 4 of an internal combustion engine 5. The seal 6 protects an upper region 7 of a nozzle body 8, which is clamped against a holding body (not shown) of the fuel injector 1 by the nozzle clamping nut 3, against combustion products from a combustion chamber 9 of the internal combustion engine 5, into which combustion chamber the nozzle body 8 projects axially with a lower nozzle shank 10. In particular, the seal 6 protects a transition region 11 between an axial nozzle shank 10 and a nozzle collar 12 (annular shoulder) of the nozzle body 8 against the abovementioned combustion products, the nozzle clamping nut 3 bearing in the axial direction against said nozzle collar 12 and thus applying force to the nozzle body 8 in the axial direction.

The fuel injector 1 is subjected to a clawing force downward in the axial direction of the plane of the drawing against the cylinder head 4 by means of a claw (not illustrated).

In the exemplary embodiment shown, the seal 6 comprises a metal disk 13 which is designed as a copper disk and onto which an elastomeric, annular sealing compound 14 is vulcanized. The elastomeric sealing compound 14 is supported inward in the radial direction on the nozzle shank 10 by a radial sealing force. At the same time, the elastomeric sealing compound 14 rests directly on the cylinder head 4 by means of an axial sealing lip 15, and therefore not only prevents gas from passing through in the direction of the transition region 11 of the nozzle body 8 but also into the surroundings.

FIG. 1a shows a top view of the seal 6 of the fuel injector 1 from below, i.e. in the viewing direction A indicated. It can be seen that an inner circumference 16 of the metal disk 13 is provided with a toothing 17 in order to ensure optimum retention of the elastomeric sealing compound 14.

It follows from FIG. 1b that the seal 6 bears against a section 18 of the nozzle body 8, which section widens conically upward in the axial direction, as a result of which self-centering of the seal 6 is obtained.

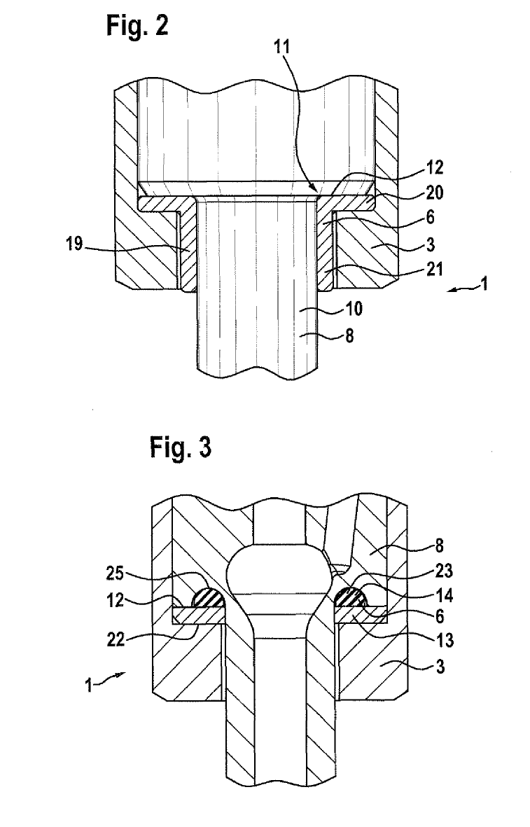

FIG. 2b shows an alternative variant embodiment of a fuel injector 1. A seal 6 is also provided in this variant embodiment to protect the transition region 11 between a nozzle shank 10 of the nozzle body 8 and the nozzle collar 12 of the nozzle body 8. In contrast to the previously described exemplary embodiment, the seal 6 according to FIG. 2 does not comprise elastomer material—but rather involves a metal collar sleeve 19 which is shrunk onto the nozzle body 8. The collar sleeve 19 which is designed as a shrink-on sleeve comprises a collar section 20 which extends in the radial direction and is clamped axially between the nozzle collar 12 and the nozzle clamping nut 3. The collar section 20 protrudes inwards in the radial direction as far as the nozzle shank 10 where it merges into an axial sleeve section 21 which is penetrated downward in the axial direction by the nozzle shank 10. The axial sleeve section 21 bears in a sealing manner on the nozzle shank 10 such that gas is reliably prevented from entering into a region radially between the axial sleeve section 21 and the nozzle shank 10, as a result of which the transition region 11 is reliably protected.

FIG. 3 shows a further alternative variant embodiment. A seal 6 which is held axially between the nozzle body 8 and the nozzle clamping nut 3, or more precisely between the nozzle collar 12 and an inner annular shoulder 22 of the nozzle clamping nut 3, can again be seen. The seal 6 is of two-part design and comprises an elastic sealing compound 14 which is designed as an independent annular element 23, here as an O-ring seal, which is clamped in the axial direction between the nozzle body 8 and a metal disk 13 acting as a supporting disk. An annular groove 25 (undercut) in a lower end side of the nozzle collar 12 is provided for receiving the annular element 23. In the variant embodiment shown, the greatest mechanical stresses occur as a result of the curved, in particular semicircularly curved, inner geometry of the annular groove 25 in an upper region of the annular groove 25, which is reliably protected from condensate and condensate products by the annular element 23.

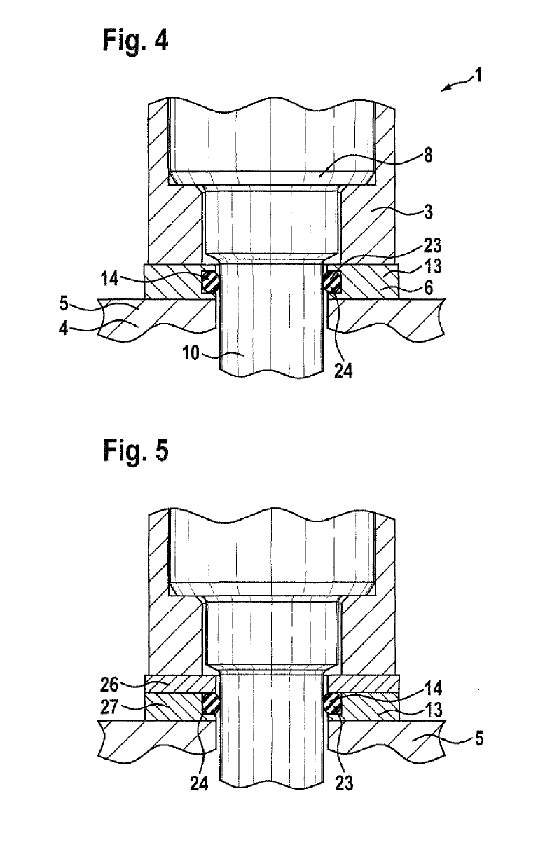

FIG. 4 shows a further exemplary embodiment, in which a seal 6 is provided which, in the alternative according to FIG. 4, is arranged axially between the nozzle clamping nut 3 and the cylinder head 4 of the internal combustion engine 5. The seal 6 comprises a metal disk 13 which has, on the inner circumference thereof, an inner circumferential groove 24 in which the elastic sealing compound 14, which is designed as the annular element 23, is received. The elastic sealing compound 14 presses radially inward with a radial force against the nozzle shank 10 of the nozzle body 8.

FIG. 5 differs from the exemplary embodiment according to FIG. 4 in that the metal disk 13 is of two-part design rather than of single-part design and consists of two partial disks 26, 27, which bear against each other in the axial direction and which, on the inner circumference therebetween, form an inner circumferential groove 24 for receiving the sealing compound 14 which is designed as the annular element 23 and is a component which is independent of the metal disk 13. If required, at least one, preferably only one, further partial disk can be provided, preferably between the partial disk 26 and the nozzle clamping nut 3, in order thereby to be able to adapt the fuel injector 1 to different installation conditions on different internal combustion engines 5 in a simple manner.

1. A fuel injector, for injecting fuel into a combustion chamber (9) of an internal combustion engine (5), with a nozzle body (8) which is designed to project into the combustion chamber (9) and is clamped to a holding body by a nozzle clamping nut (3), and with a seal (6) for sealing off the combustion chamber (9) from a nozzle body region.

2. The fuel injector as claimed in claim 1, characterized in that the seal (6) is arranged at least one of, at least partially axially between the nozzle body (8) and the clamping nut (3), at least approximately axially between the clamping nut cal and the internal combustion engine (5).

3. The fuel injector as claimed in claim 1, characterized in that the seal (6) comprises an elastic sealing compound (14).

4. The fuel injector as claimed in claim 3, characterized in that the sealing compound (14) is arranged in at least one of a radially and an axially sealing manner.

5. The fuel injector as claimed in claim 3, characterized in that the elastic sealing compound (14) is vulcanized onto a metal disk (13).

6. The fuel injector as claimed in claim 5, characterized in that an inner circumferential contour of the metal disk (13), which contour is adjacent radially on the inside to the sealing compound (14), is textured.

7. The fuel injector as claimed in claim 3, characterized in that the elastic sealing compound (14) comprises a sealing lip (15) which is designed to bear axially on the internal combustion engine (5).

8. The fuel injector as claimed in claim 3, characterized in that the sealing compound (14) is designed as an annular element (23) held in a form-fitting manner in a metal disk (13).

9. The fuel injector as claimed in claim 8, characterized in that the metal disk (13) is of multipart design.

10. The fuel injector as claimed in claim 3, characterized in that the sealing compound (14) is designed as an annular element (23) which is arranged in a groove on an end side of the nozzle body (8).

11. The fuel injector as claimed in claim 1, characterized in that the seal (6) comprises a collar sleeve (19).

12. (canceled)

13. The fuel injector as claimed in claim 5, characterized in that the elastic sealing compound (14) is vulcanized onto a copper disk.

14. The fuel injector as claimed in claim 6, characterized in that the inner circumferential contour of the metal disk (13) is textured by the provision of a toothing structure.

15. The fuel injector as claimed in claim 8, characterized in that the metal disk (13) is a copper disk.

16. The fuel injector as claimed in claim 9, characterized in that the annular element (23) is held axially between two metal parts in a groove.

17. The fuel injector as claimed in claim 11, characterized in that the collar sleeve (19) is designed as a shrink-on sleeve.

18. The fuel injector as claimed in claim 11, characterized in that the collar sleeve (19) is a metal sleeve.

19. An internal combustion engine comprising:
a combustion chamber (9); and
a fuel injector (1) having a nozzle body (8) that projects into the combustion chamber (9) and is clamped to a holding body by means of a nozzle clamping nut (3), the fuel injector further including a seal (6) for sealing off the combustion chamber (9) from a nozzle body region.

20. The internal combustion engine as claimed in claim 19, characterized in that the seal (6) is arranged at least partially axially between the nozzle body (8) and the clamping nut (3).

21. The internal combustion engine as claimed in claim 19, characterized in that the seal (6) is arranged at least approximately axially between the clamping nut (3) and the internal combustion engine (5).
